(19) United States
(12) Patent Application Publication
(10) Pub. No.: US 2007/0254139 A1
(43) Pub. Date: Nov. 1, 2007

(54) Device for Foam-Coating and/or Spraying a Substantially Flat Workpiece

(75) Inventor: Martin Seebass, Gauting (DE)

Correspondence Address: ROBERTS, MLOTKOWSKI & HOBBES, P. O. BOX 10064, MCLEAN, VA, 22102-8064, US

(73) Assignee: WEBASTO AG, Stockdorf (DE)

(21) Appl. No.: 11/719,999

(22) PCT Filed: Oct. 24, 2005
(86) PCT No.: PCT/DE05/01904

§ 371 Date: May 23, 2007

(30) Foreign Application Priority Data
Nov. 23, 2004 (DE) 10 2004 056 479.5

(51) Int. Cl. B32B 3/00

(52) U.S. Cl. 428/172

(57) ABSTRACT

A device for in situ foaming and/or injection molding an essentially plate-shaped workpiece (14), especially a transparent cover element of a vehicle roof, has a tool unit (10) with an upper tool (18) and a lower tool (20) which, together, form a mold cavity (22) for forming a frame in the area of the edge of the workpiece (14). The tool unit (10) encloses at least one elastically deformable shaped gasket (30) which, with the tool unit (10) closed, adjoins the edge surface of the workpiece (14) in an area adjoining a recessed region of the frame, so that the workpiece (14) is free of foamed or injection molded material adjoining the recessed region after the process of in situ foaming or injecting has been completed.

### BACKGROUND OF THE INVENTION

1. Field of the Invention

The invention relates to a device for at least one of foaming and injection molding of an essentially plate-shaped workpiece in place, especially a transparent cover element of a vehicle roof, having a tool unit with an upper tool and a lower tool which, together, form a mold cavity for forming a frame in the area of the edge of the workpiece.

2. Description of Related Art

In the field of motor vehicles, plate-shaped, flat or even arched workpieces are used in diverse ways. The workpiece is designed, for example, as a glass plate which is a component of a transparent sliding roof or lifting and sliding roof and forms the cover element of one. The glass plate in this application generally has a plastic frame which is formed from a thermoplastic or also from polyurethane foam and can be used for attachment of insert parts and/or to form a peripheral gasket. The insert parts can constitute a connecting element for linking the glass plate to a drive mechanism. The plastic frame is conventionally foamed or injection molded onto the glass plate in a molding tool.

A device of the initially named type which is designed as a molding tool is known from German Patent Application DE 101 07 743 A1 and corresponding to U.S. Pat. No. 6,764,290 and is used to produce a plastic frame of a transparent cover element of a sliding roof, a lifting and sliding roof or a spoiler roof of a motor vehicle. This device comprises a tool unit which is provided with a lower tool and an upper tool for forming a mold cavity and is used to accommodate a glass plate so that a plastic frame can be foamed onto it. The mold cavity is sealed, on the one hand, by steel/steel contact formed by the lower tool and the upper tool and on the other by glass/steel contact formed by the tool unit and the glass plate.

Furthermore, glass plates which are used for cover elements are generally provided with a so-called C-cut on their edges. For aesthetic reasons, it has been desirable for the edge surface made as a C-cut to be kept free of the in situ foaming or injection, at least in regions. Sealing which is necessary for this purpose, especially partial or also peripheral sealing of the cut edge surface in the regions of its radii, when using existing foaming tools is, however, not possible to the extent that a polyurethane foam can be produced in suitable visual quality since sealing of the mold cavity via glass/steel contact is not suited for this purpose in the regions of the radii.

### SUMMARY OF THE INVENTION

The object of the invention is to devise a device for foaming and/or injection molding of an essentially plate-shaped workpiece in situ for forming a plastic frame with partial recesses, the recesses having clearly defined edges.

This object is achieved by the device of the invention in which the tool unit has at least one elastically deformable shaped gasket which adjoins the edge surface of the workpiece at least in the frame-forming cavity region with the tool unit closed so that, after the in situ foaming or injection molding of the frame, the workpiece is free of foamed or injected material at least in the region adjoining the frame.

The heart of the invention therefore involves forming a region free of the foaming or injection molding on the edge surface of the workpiece using a tool unit with a molded gasket which positively adjoins the pertinent edge surface of the workpiece, and in this connection, due to its deformability, has a clearly defined contact surface so that the frame of the workpiece to be produced can be provided with a visually defined recess. The mold cavity in the area in which the recessed region is to be formed is sealed by the contact between the elastically deformable shaped gasket and the plate-shaped workpiece. The device in accordance with the invention contributes significantly to a positive visual appearance of the finished workpiece.

The device in accordance with the invention can be used, fundamentally, for any plate-shaped workpieces which are inserted into a tool unit for in situ foaming and/or injection molding with a frame. In particular, by means of the device in accordance with the invention, flat or curved glass plates which are used in a motor vehicle, for example, as a cover element of a sliding glass roof can be processed. In this case, the glass plate is provided in the tool unit with a plastic frame which is formed, for example, of a polyurethane foam, and is used to accommodate a peripheral gasket and/or to connect the insertion parts to the glass plate so that the glass plate can be joined to the vehicle superstructure and a sliding roof drive.

In this connection, the term “glass plate” is defined as the indicated plate-shaped workpiece formed of an at least partially transparent material, such as glass or a transparent plastic.

Especially advantageous contact behavior of the shaped gasket with the pertinent edge surface of the workpiece can be achieved when the shaped gasket has a front side which at least partially adjoins the edge surface of the workpiece, with an essentially V-shaped cross section. If the edge surface of the workpiece then has a curved cross section, when the workpiece has been inserted into the tool unit, the shaped gasket is advantageously first placed tangentially on the pertinent edge surface in order to then produce positive locking with the workpiece in the recessed region by the pressure which builds up when the tool unit is closed. In one special version, the material which is used for the plastic frame and which is placed in the mold cavity can then penetrate into the wedge-shaped gap between the workpiece and the shaped gasket and can set there.

In order to achieve simple interchangeability of the shaped gasket in a manner easy to install, the shaped gasket is inserted preferably into a slotted recess of the tool unit.

The slotted recess for the shaped gasket is formed by a tool insert in a special embodiment of the device in accordance with the invention. This version can be easily manufactured.

In particular, when foaming glass plates in place with a polyurethane frame, tolerances generally occur in the dimensions of the glass plate. To be able to equalize these tolerances and to always have the same mold images produced by the shaped gasket, the shaped gasket preferably lies on a strip-like thrust piece on which the positioning mechanism acts. The shaped gasket can thus be positioned in position (x, y and/or z) depending on the dimensions of the workpiece.

In one special embodiment of the device in accordance with the invention, the positioning means comprises at least one adjusting screw. This adjusting screw can generally be actuated manually and preferably without a tool, but can also be provided with a motorized drive.

Favorable temperature and deformation behavior of the shaped gasket can be achieved when it is made of silicone. Alternatively, the shaped gasket can also be produced from other elastically deformable plastics.

Transparent cover elements of sliding roofs or the like produced from glass or plastic are generally made with profiled edge surfaces, the profiling being made especially as a so-called C-cut profile. This means that the transparent cover element is made without sharp edges even before its foaming or injection in place with the frame.

Cover elements which are used in the roof region of motor vehicles generally have an essentially square and especially rectangular plan, then in the tool unit in the region of one or more side edge surfaces of the plate-shaped workpiece, there can be a respective shaped gasket. Fundamentally, depending on the requirement, the location of the shaped gaskets with respect to the workpiece can be freely selected.

Other advantages and advantageous configurations of the subject matter in accordance with the invention can be taken from the following description when viewed in conjunction the drawings.

### BRIEF DESCRIPTION OF THE DRAWINGS

FIG. 1 shows a top view of a tool unit of the device in accordance with the invention;

FIG. 2 shows a section along the line II-II in FIG. 1;

FIG. 3 shows an enlargement of the encircled region III in FIG. 2;

FIG. 4 shows a top view of the lower tool of the tool unit as shown in FIG. 1;

FIG. 5 shows an enlargement of the region V in FIG. 4;

FIG. 6 shows a perspective front view of a shaped gasket of the tool unit;

FIG. 7 shows a cross section through the shaped gasket as shown in FIG. 6;

FIG. 8 shows the side region of the cover element of a sliding vehicle roof; and

FIG. 9 shows a section through the cover element as shown in FIG. 8 along the line IX-IX in FIG. 8.

### DETAILED DESCRIPTION OF THE INVENTION

One embodiment of the device in accordance with the invention and a cover element of a motor vehicle roof produced with this device are shown schematically simplified in the drawings.

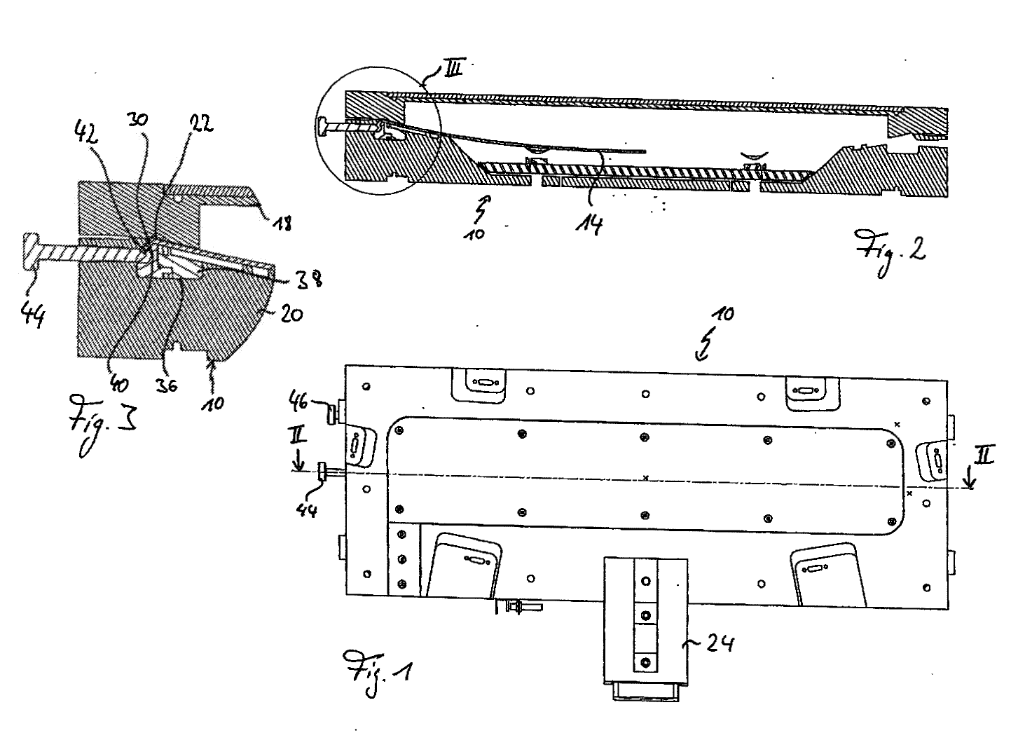

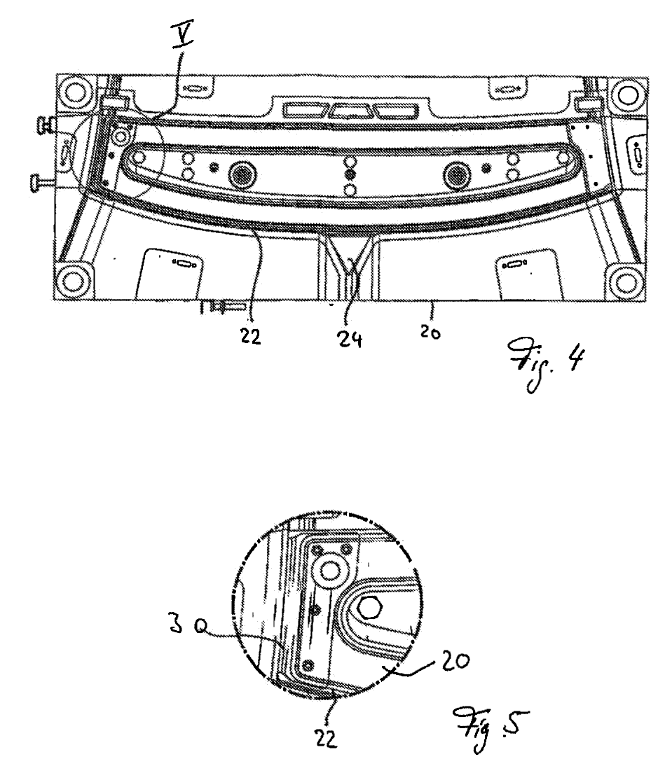

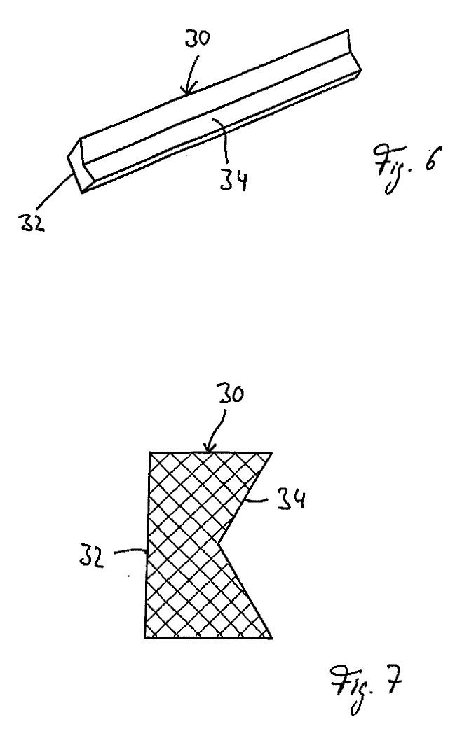

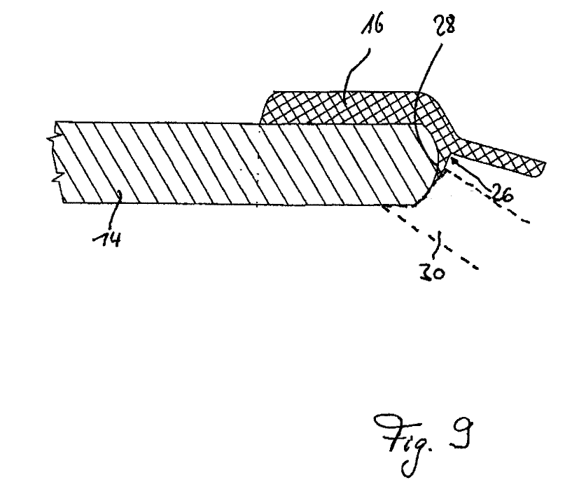

FIGS. 1 to 7 show a tool unit 10 for producing a polyurethane plastic frame 16 of the cover element 12 of a motor vehicle roof shown in FIGS. 8 & 9. The cover element 12 comprises a slightly curved glass plate 14 which is provided with a plastic frame 16. The plastic frame 16, in the installation position of the cover element 12 assumes sealing functions in conjunction with it being cementing on the roof frame.

The device comprises a tool unit 10 which is connected to a mold carrier (not shown) and has an upper tool 18 and a lower tool 20. The upper tool 18 can be connected to the upper carrier unit of the mold carrier. The lower tool 20 can be connected to the lower carrier unit of the mold carrier.

The tool unit 10, in the production of the plastic frame 16, holds the glass plate 14 and defines a mold cavity 22 in which a polyurethane material is placed to form the plastic frame 16 via the gate region 24 so that it foams in place to form the plastic frame 16 in the mold cavity 24.

To form a recessed or notched region 26 in the area of the edge surface 28 of the glass plate 14, which surface is made as a C-cut, in the corresponding regions of the lower tool 20, there are shaped gaskets 30, of which the drawings show only the shaped gasket 30 in the left-hand region of the tool unit 10. The gasket which is located in the right-hand region of the tool unit 10 is positioned mirror-symmetrically to the gasket which is located in the left-hand region of the tool unit 10.

In the closed state of the tool unit 10, and when the glass plate 14 is held, each of the two shaped gaskets 30 adjoin the respective edge surface of the glass plate with a large amount of positive locking to the respective edge surface of the glass plate so that polyurethane is prevented from being foamed onto the glass plate in the area adjoining respective recessed region 26 in an exact manner. The respective recessed region 26 of the polyurethane frame 16 thus acquires clearly defined edges.

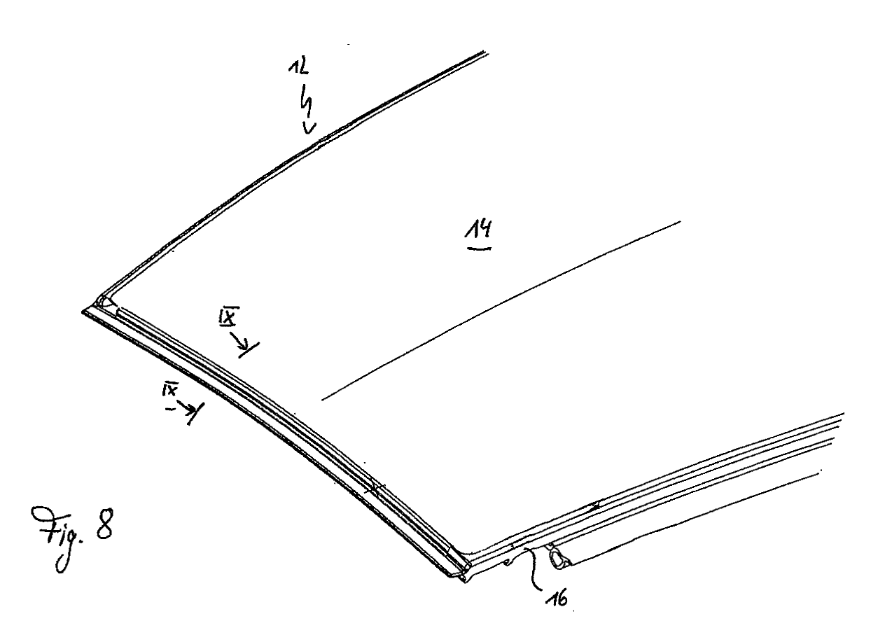

A beam-like design of the shaped gasket 30 is shown, for example, in FIGS. 6 & 7. As these figures show, the shaped gasket 30 has an essentially rectangular base surface 32 and a front surface 34 which has an essentially V-shaped cross section. An especially good sealing result in the region of the edge surface 28 can be achieved by this shaping of the front surface 34.

In the region of the respective shaped gasket 30, the lower tool 20 of the tool unit 10 also has a two-part insert 38 which is fitted into the recess 36 and which forms a slotted recess 40 which is aligned parallel to the side edges of the glass plate 14 and into which the respective shaped gasket 30 is fitted.

The shaped gasket 30 rests on a strip-like thrust piece 42 on which a positioning means formed from two adjusting screws 44, 46 acts, so that the contact pressure of the shaped gasket 30 against the glass plate 14 can be adjusted. The shaped gasket 30, which constitutes an elastically deformable component, is produced from silicone in this case.

The contact of the shaped gasket 30 with the edge surface 28 of the glass plate 14 is shown by the broken line in FIG. 9. In this case, the shaped gasket 30 is brought into contact with the edge surface 26 obliquely downward.

What is claimed is:

1-10. (canceled)

11. Device for at least one of foaming and injection molding of a frame onto an essentially plate-shaped workpiece in situ, comprising a tool unit with an upper tool and a lower tool which, together, form a mold cavity for forming the frame in an area of an edge surface of the workpiece,
wherein at least one recess is formed by the mold tools adjoining the mold cavity, and
wherein the tool unit has at least one elastically deformable shaped gasket which is received in the at least one recess and adjoins the edge surface of the workpiece at least in an area at a side of the mold cavity with the tool unit in a closed position, so that the frame has a defined edge adjoining the workpiece and surfaces of the workpiece adjoining the frame are free of material used to form the frame after formation of the frame by said at least one of in situ foaming or injection molding.

12. Device as claimed in claim 11, wherein the workpiece is a transparent cover element of a vehicle roof.

13. Device as claimed in claim 11, wherein the shaped gasket has a front side with an essentially V-shaped cross section which at least partially adjoins the edge surface of the workpiece.

14. Device as claimed in claim 11, wherein the at least one recess for the shaped gasket is formed by a tool insert.

15. Device as claimed in claim 11, wherein the shaped gasket rests on a strip-like thrust piece and wherein a positioning means acts on the thrust piece for adjusting a contact pressure of the shaped gasket on the workpiece.

16. Device as claimed in claim 15, wherein the positioning means comprises at least one adjusting screw.

17. Device as claimed claim 11, wherein the shaped gasket is made of silicone.

18. Device as claimed claim 11, wherein the edge surface of the workpiece adjoined by the shaped gasket is curved.

19. Device as claimed in claim 18, wherein the edge surface of workpiece is a C-shaped curved profile.

20. Device as claimed claim 11, wherein the workpiece is essentially rectangular and said at least one shaped gasket comprises a gasket each of plural side edge surfaces of the workpiece.

21. Device as claimed in claim 12, wherein the shaped gasket has a front side with an essentially V-shaped cross section which at least partially adjoins the edge surface of the transparent cover element.

22. Device as claimed in claim 12, wherein the at least one recess for the shaped gasket is formed by a tool insert.

23. Device as claimed in claim 12, wherein the shaped gasket rests on a strip-like thrust piece and wherein a positioning means acts on the thrust piece for adjusting a contact pressure of the shaped gasket on the transparent cover element.

24. Device as claimed in claim 23, wherein the positioning means comprises at least one adjusting screw.

25. Device as claimed claim 12, wherein the edge surface of the transparent cover element adjoined by the shaped gasket is curved.

26. Device as claimed in claim 25, wherein the edge surface of the transparent cover element is a C-shaped curved profile.

27. Device as claimed claim 12, wherein the transparent cover element is essentially rectangular and said at least one shaped gasket comprises a gasket each of plural side edge surfaces of the workpiece.

28. Process of in situ forming a frame on a workpiece, comprising the steps of:
providing a tool unit with an upper tool and a lower tool which, together, form a mold cavity for forming the frame in an area of an edge surface of the workpiece,
providing at least one elastically deformable shaped gasket in at least one recess of the tool unit so that the shaped gasket adjoins the edge surface of the workpiece at least in an area at a side of the mold cavity with the tool unit in a closed position,
at least one of in situ foaming or injection molding a material in said cavity to form the frame with the at least one shaped gasket producing a defined edge on the frame adjoining the workpiece with surfaces of the workpiece adjoining the frame being free of material used to form the frame.

29. Process according to claim 28, wherein the workpiece is a transparent cover element of a vehicle roof.
